(19) United States
(12) Patent Application Publication
(10) Pub. No.: US 2026/0111495 A1
(43) Pub. Date: Apr. 23, 2026

(54) DATA INTEGRATION FOR DOCUMENTS INCLUDING STRINGS USING MULTIPLE TECHNIQUES AND CONFIDENCE SCORING

(71) Applicant: Truist Bank, Charlotte, NC (US)

(72) Inventors: Rama Krishna Nethi, Atlanta, GA (US); Swati Agrawal, Johns Creek, GA (US); John Eric Crabtree, Atlanta, GA (US)

(73) Assignee: Truist Bank, Charlotte, NC (US)

(21) Appl. No.: 18/921,585

(22) Filed: Oct. 21, 2024

Related U.S. Application Data
(63) Continuation of application No. 18/921,349, filed on Oct. 21, 2024.

(51) Int. Cl. G06F 16/903; G06F 16/93

(52) U.S. Cl. CPC G06F 16/90344; G06F 16/93

(57) ABSTRACT

A system can be used for data integration for strings using multiple techniques and confidence scoring. The system can receive, from a client device, a document including a set of input strings, each input string including at least one text character. The system can, for each input string of the set of input strings, compute one or more scores for the input string using one or more respective scoring techniques, in which each score of the one or more scores corresponds to a measure of a similarity between the input string and another string. The system can select a first score of the one or more scores using a predefined criteria, the first score having a corresponding first string. The system can update the document using the first string.

### CROSS-REFERENCE TO RELATED APPLICATIONS

The present application is a continuation of U.S. patent application Ser. No. 18/921,349, filed Oct. 21, 2024, titled “DATA INTEGRATION FOR STRINGS USING MULTIPLE TECHNIQUES AND CONFIDENCE SCORING,” the entirety of which is incorporated herein by reference.

### TECHNICAL FIELD

The present disclosure relates generally to data integration and, more particularly (although not necessarily exclusively), to data integration for strings using multiple techniques and confidence scoring.

### BACKGROUND

Data integration involves using a combination of computational techniques to combine data from various sources to obtain a desired configuration. Examples of data integration scenarios include merging datasets from different databases, transforming data formats to match a particular format, or resolving inconsistencies across different data sets to maintain consistency across data sources.

One data integration scenario involves matching strings from disparate data sources. Entities can be referred to using various nomenclature or may be referred to using slight variations or misspellings. Data consumers typically require entities to be referred to consistently using the same identifier across data sources. Therefore, entities may be associated with a “master” string that represents a particular chosen designation for the entity to be used across data sources. Nevertheless, input data may include variations, errors, abbreviations, or other differences that cannot be easily matched with the master strings.

### SUMMARY

In one example, a system includes one or more processors and one or more computer-readable storage media for storing instructions that are executable by the one or more processors to cause the system to perform certain operations. The system can receive, from a client device, a document including a set of input strings, each input string including at least one text character. The system can, for each input string of the set of input strings, compute one or more scores for the input string using one or more respective scoring techniques, in which each score of the one or more scores corresponds to a measure of a similarity between the input string and another string. The system can select a first score of the one or more scores using a predefined criteria, the first score having a corresponding first string. The system can update the document using the first string.

In another example, a method involves a computing device receiving, from a client device, a document including a set of input strings, each input string including at least one text character. The computing device can, for each input string of the set of input strings, compute one or more scores for the input string using one or more respective scoring techniques, in which each score of the one or more scores corresponds to a measure of a similarity between the input string and another string. The computing device can select a first score of the one or more scores using a predefined criteria, the first score having a corresponding first string. The computing device can update the document using the first string.

In another example, a non-transitory computer-readable medium stores instructions that, when executed by one or more processors, can cause the one or more processors to perform operations including receiving, from a client device, a document including a set of input strings, each input string including at least one text character. The operations can include, for each input string of the set of input strings, computing one or more scores for the input string using one or more respective scoring techniques, in which each score of the one or more scores corresponds to a measure of a similarity between the input string and another string. The operations can include selecting a first score of the one or more scores using a predefined criteria, the first score having a corresponding first string. The operations can include can updating the document using the first string.

### BRIEF DESCRIPTION OF THE DRAWINGS

FIG. 1 is a schematic of an example of a string matching system for data integration for strings using multiple techniques and confidence scoring, according to some aspects of the present disclosure.

FIG. 2 depicts a flowchart of a process that can be used by a system configured for data integration for strings using multiple techniques and confidence scoring, according to some examples of the present disclosure.

FIG. 3 depicts another flowchart of a process that can be used by a system configured for data integration for strings using multiple techniques and confidence scoring, according to some examples of the present disclosure.

FIG. 4 depicts an example of one scoring technique, according to some aspects of the present disclosure.

FIG. 5 depicts another example of a scoring technique, according to some aspects of the present disclosure.

FIG. 6 depicts an example of yet another scoring technique, according to some aspects of the present disclosure.

FIG. 7 is a block diagram of an example of a system for data integration for strings using multiple techniques and confidence scoring, according to some aspects of the present disclosure.

### DETAILED DESCRIPTION

Certain aspects and examples of the present disclosure relate to data integration for strings using multiple techniques and confidence scoring. Data integration for strings can refer generally to matching strings, also referred to as text, received from various sources with one or more “master” strings. The master strings can each be a predetermined canonical reference string. Master strings may be selected to ensure that certain entities are referred to uniformly across various data sources within an organization.

For example, consider an organization that manages numerous named accounts. Each account may be referred to using a string identifier, such as an account name. However, variations on the account name may be commonly used both internally and externally to the organization. For example, a first database may refer to an account as “TechCo, Inc.” while a second database refers to the same account as “TechCo, Incorporated”. An external data source, such as a document or spreadsheet provided by a third party may refer to the same account using an acronym such as “TCI”.

All three examples are referring to the same entity and yet any attempt to match them to each other using existing approaches involving exact string matching techniques would be frustrated by failure. Furthermore, the organization may desire to refer to the account using only the master string “Tech Company Incorporated” wherever it is referenced. In that case, none of the account names from any of the data sources, both internal and external, will be matched to the master string using exact string matching techniques. For instance, a comparison between “TechCo, Inc.” and “Tech Company Incorporated” would determine that the strings are not exact matches. Even where existing approaches use more sophisticated string matching techniques, such techniques may not be effective in all cases, resulting in an unacceptably high rate of missed matches.

Consequently, data stores such as databases, spreadsheets, filesystems, may include multiple persisted versions of entries referring to the same entity. This redundancy can result inconsistencies that both waste storage space and complicate data management. For example, inconsistent representations of the same entity across different data sources can cause confusion and errors, particularly when data from multiple sources is compared or is dependent on other sources. Additionally, data management tasks can become untenably complex, as maintaining multiple versions of the same entity requires updates and corrections to be replicated across all versions, adding a time-consuming and error-prone burden for data management teams. Likewise, various automated processes, such as data synchronization, reporting, and business intelligence, rely on accurate and consistent data. Multiple versions of an entity can disrupt these processes, leading to inefficiencies and errors. The user experience of consumers of data products can be adversely affected, where, for example, it cannot be determined which version of an entity is accurate or up-to-date.

These challenges can be addressed using multiple techniques for string matching in concert with confidence scoring. The multiple techniques for string matching can refer generally to any approach for determining whether an input string “matches” another string, such as a master string designated as the canonical reference or designation for an entity. In this respect, “matches” does not necessarily mean the two strings are identical or even cosmetically similar. For example, an identified match for an input string may be quite different if the matched string is a designated alias of the input string.

Confidence scoring can refer generally to the computation of a value, such as a number, each time a particular scoring technique is used to perform string matching. The confidence score thus computed can reflect the probability or likelihood that the determined match is accurate. The systems and methods disclosed herein can be used for matching strings from disparate data sources using multiple techniques and confidence scoring to identify an optimized string match.

The following example method is introduced to illustrate some of these concepts. In the example method a system receives, from a client device, an input string such as “TechCo Inc.” For example, the input string may be an individual string input using a suitable graphical user interface (“GUI”) using the client device or it may be one among a number of strings included in a document such as a spreadsheet. The input string may correspond to a particular entity or detail thereof such as a name or location. Such words may frequently be written, spelled, or abbreviated in a variety of ways.

The system then computes one or more scores for the input string using one or more respective scoring techniques. The scores can correspond to a measure of a similarity between the input string and another string. For example, the scoring techniques may involve looking for exact matches against known aliases associated with members of a collection of master strings for possible input strings. Another technique can involve performing a keyword-based comparison with the members of a collection of master strings that may match with the input string. Yet another technique can involve computing a similarity score between the input string and the members of the collection of master strings.

Execution of each scoring technique concludes with the output of a confidence score and a corresponding closest-matched master string. In this example, the system may compute a score of 70 matching a master string “TechCo Incorporated” using a first scoring technique and a score of 50 matching the master string “Technology Company” using a second scoring technique.

Following computation of one or more scores, the system selects a score from among the computed scores using a predefined criteria such as the maximum of the computed scores. For example, the computed scores may correspond to a likelihood, probability, or confidence that the identified master string matches the input string. In this example, the system selects the score of 70, corresponding to the higher likelihood that “TechCo Incorporated” matches “TechCo Inc.” The system then outputs the selected master string. For example, where the input string is received as an entry in a spreadsheet, the spreadsheet can be updated to replace the input string with the selected master string.

In some examples of the present disclosure, the technical field related to data integration, and in particular, data integration techniques for string matching, are improved. Accuracy and consistency are improved through the employment of multiple string matching techniques that output scores corresponding to a likelihood or confidence in the identified match, reducing or eliminating errors and inconsistencies that can arise from relying on a single technique or through exact string matching. Because these improvements integrating multiple string matching techniques with confidence scoring, a more nuanced and probabilistic approach for string matching is enabled that not only increases accuracy and consistency but also addresses the inherent variability and complexity of textual data from disparate sources, achieving a level of data integration that was not feasible with existing techniques.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

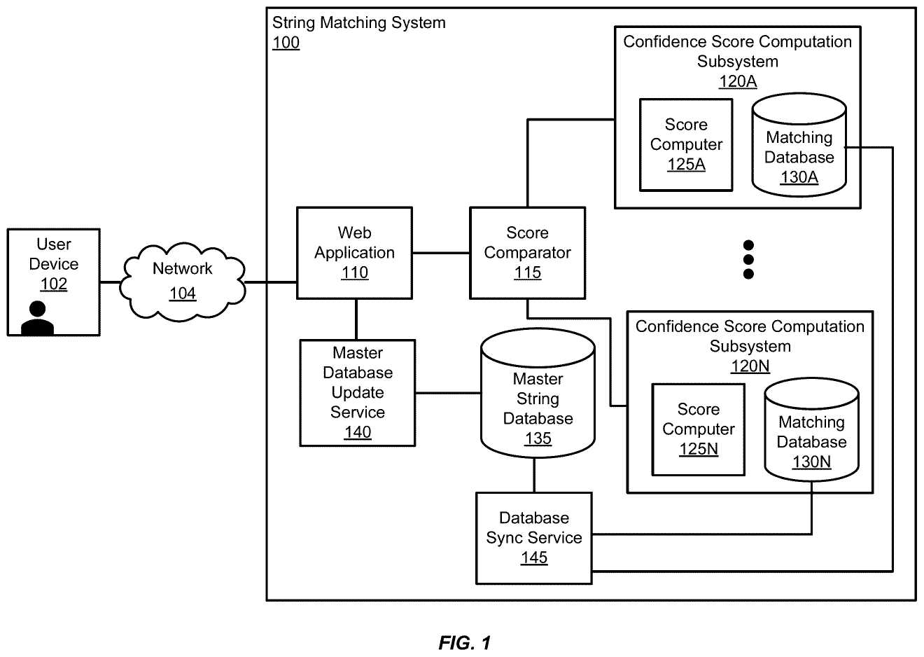

FIG. 1 is a schematic of an example of a string matching system 100 for data integration for strings using multiple techniques and confidence scoring, according to some aspects of the present disclosure. The example string matching system 100 includes a number of components implementing data integration for strings using multiple techniques and confidence scoring. The components may be implemented using software, hardware, or a combination of both. The components may be hosted on “on-premise” server hardware, virtual machines thereon, in a cloud computing environment, or using any combination of these or similar hosting environments.

String matching system 100 includes web application 110. The web application 110 can provide a web-based GUI for the user device 102 to interact with the string matching system 100 over network 104. The user device 102 may communicatively coupled with the string matching system 100 via network 104. The network 104 may be a public network, private network, or a hybrid network that combines elements of both public and private network. For example, network 104 may include a local area network (“LAN”), wide area network (“WAN”), metropolitan area network (“MAN”), wireless local area network (“WLAN”), storage area network (“SAN”), or virtual private network (“VPN”), as well as a combination of networks accessing the string matching system 100 over the Internet. The user device 102 may include client devices like laptops, desktops, smartphones, tablets, and the like. The user device 102 can execute a web browser that can be used to access the GUI provided by the web application 110.

The web application 110 may include program code for receiving, from user device 102, an input string. For example, the web application 110 may provide a GUI or an application programming interface (“API”) through which input strings or documents containing such strings can be submitted. For example, the web application 110 may provide a web-based API that can be accessed by the user device 102 using the Hypertext Transfer Protocol (“HTTP”) using a set of well-defined, documented methods.

The web application 110 can further include program code for coordinating the computing of confidence scores for the input string using various scoring techniques, selecting a score according to a predefined criteria (e.g., the maximum score), and outputting the match string back to the user device 102 used the components of the string matching system 100 as described below. In some examples, the web application 110 can perform preprocessing of input strings prior to passing to the downstream confidence score computation subsystems 120A..N or master database update service 140.

The string matching system 100 includes one or more confidence score computation subsystems 120A..N. Each confidence score computation subsystem 120A includes a score computer 125A and a matching database 130A. The confidence score computation subsystems 120A..N can be configured to each compute one or more confidence scores for a received input string using a particular scoring technique or techniques. Each computed score can correspond to an identified master string on in the matching database 130A.

In some examples, the score computer 125A computes a confidence score by applying the particular scoring technique to the input string and all or some of the master strings, or representative versions thereof, to determine an intermediate score. Then, the score that is determined for the input string can be an intermediate score selected according to some criteria, typically a maximum.

The score computer 125A can include program code implementing the respective scoring technique. For example, the score computer 125A can implement an exact matching or known alias technique, a keyword search, or a similarity score computation, among other possibilities. FIG. 1 depicts string matching system 100 as including a number of possible confidence score computation subsystems 120A..N. In practice, any number of confidence score computation subsystems 120A..N can be included in string matching system 100, subject to physical or practical limitations.

Each confidence score computation subsystem 120A includes a matching database 130A. The matching database 130A may be a relational database, including a hierarchical table structure for managing relationships between entities (e.g., users, groups, permissions, etc.). In some other examples, the external user database may use alternative technologies including document-based databases, graph databases, or key-value stores. The matching database 130A may be abstracted and accessible through an application programming interface (“API”), such that the implementation details of the matching database 130A are not visible to the score computer 125A. For instance, the matching database 130A may be accessible through an API utilizing technologies like Representational State Transfer (“REST”), GraphQL, Remote Procedure Calls (“RPCs”), or the Simple Object Access Protocol (“SOAP”), among others.

Each of the matching databases 130A..N can be populated with information needed to implement the particular scoring technique implemented in its respective confidence score computation subsystem 120A such as match words to measure against the input strings. The match words may be, for example, master strings as described above. For example, an exact string matching or known-aliases matching technique may be implemented by populating the matching database 130A with a collection of master strings and a number of known aliases for each master string. Each confidence score computation subsystem implementation may involve populating the respective matching database 130A with different information, although each implementation includes at least a number of possible master strings.

In some examples, the matching databases 130A..N may include a number of different collections of data used for confidence scoring. For example, each collection of data may correspond to a different type, category, or classification of input string so that the string matching system 100 can be used to support various contexts. For example, the matching databases 130A..N may be partitioned using schemas or tables such that a portion of the database is used for matching account name type input strings while another portion of the database is used for matching location type input strings.

The matching databases 130A..N can be initially populated and periodically updated by a database synchronization (“sync”) service 145. The database sync service 145 can include program code to populate each of the matching databases 130A using data from a master string database 135. As with the matching databases 130A..N, the master string database 135 may be a relational database, document store, graph databases, key-value stores, or any other suitable database type using various hosting contexts and access methods. The master string database 135 can include, for each type, category, or classification of possible input strings, the collection of anticipated master strings corresponding to that input string type. For example, if the input string is an account name, then the master string database 135 may include a collection of master strings corresponding to all account names known by an organization. The collection of master account name strings may be chosen to uniquely identify accounts across various data sources in use by the organization.

The database sync service 145 may further include program code to populate the matching databases 130A..N with additional data and representations of the master strings used by the scoring computers 125A..N. For example, a scoring technique that uses vectorized representations of the input string and the master strings can be facilitated by precomputing vector representations of the master strings as they are initially or periodically copied to the matching databases 130A..N.

The matching databases 130A..N can be initially populated using the master strings from the master string database 135, and associated alternative representations or other data (e.g., aliases), upon the first use or installation of the string matching system 100, upon updates to one or more master strings or other data, as described below, or upon being caused to populate by a suitable manual command.

The master string database 135 can be updated from time to time. For example, new master strings can be added to the master string database 135. In that case, the database sync service 145 can be configured to propagate out updates to the master string database 135 upon any changes being made to the master string database 135. The string matching system 100 includes a master database update service 140 that can be used to enable receipt of master string updates from the user device 102. For example, the user device 102, upon receipt of a confidence score and matching master string, may be caused to update the master string using a suitable GUI using a desired override string. The master database update service 140 can provide methods for creating new master strings, updating existing master strings, or deleting existing master strings. In addition to propagating out changes when updates are made, the database sync service 145 can be configured to periodically update or refresh the data in the matching databases 130A..N.

The system includes a score comparator 115 that can receive the computed scores from the confidence score computation subsystems 120A..N and select a score using a predefined criteria. For example, the score comparator 115 can be configured to select the maximum score from among the confidence score computation subsystems 120A..N. The score comparator 115 can include procedures for various possibilities that may arise during the scoring process. For example, where two returned confidence scores are the same, the score comparator 115 can be configured to prefer the confidence score and associated master string according to a ranking of scoring technique preferences.

The scoring comparator 115 can output the selected score to the web application 110 to be returned to the user device 102 over the network. In some examples, determination of the score may take a period of time that may exceed the typical timeout durations associated with requests from the user device 102 (e.g., HTTP request timeout). In that case, score computation can be performed asynchronously. The web application 110 can receive an input string and return a job or task identifier that can be used by the user device 102 later to retrieve the result. In some examples, the user device 102 can be connected with the web application 110 using a persistent connection such as a WebSockets connection that that be used to return the score computation and selected master string when the asynchronous task is completed.

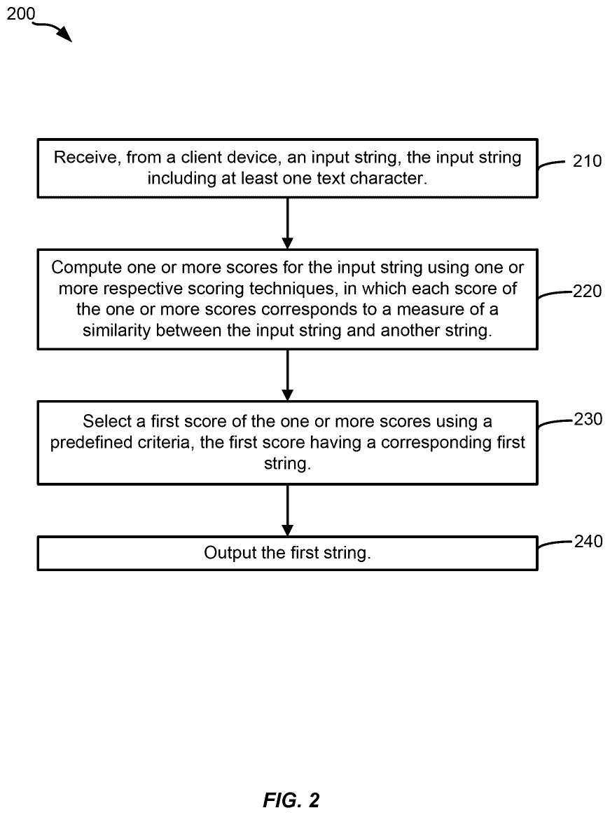

FIG. 2 depicts a flowchart of a process 200 that can be used by a system configured for data integration for strings using multiple techniques and confidence scoring, according to some examples of the present disclosure. In some examples, the string matching system 100 can implement some or all of the blocks shown in FIG. 2. The string matching system 100 can implement some or all blocks according to program code received from other components, such as components of the various confidence score computation subsystems 120A..N. Other example variations can include more blocks, fewer blocks, different blocks, or a different order of the blocks than is shown in FIG. 2. The blocks of FIG. 2 are discussed below with reference to the components discussed above in relation to FIG. 1.

At block 210, the string matching system 100 can receive, from a client device, an input string, the input string including at least one text character. For example, the input string may be received from the user device 102. The input string may be input to the user device 102 using a suitable input device such as a keyboard. The input string can be output to the string matching system 100 using a suitable web-based API.

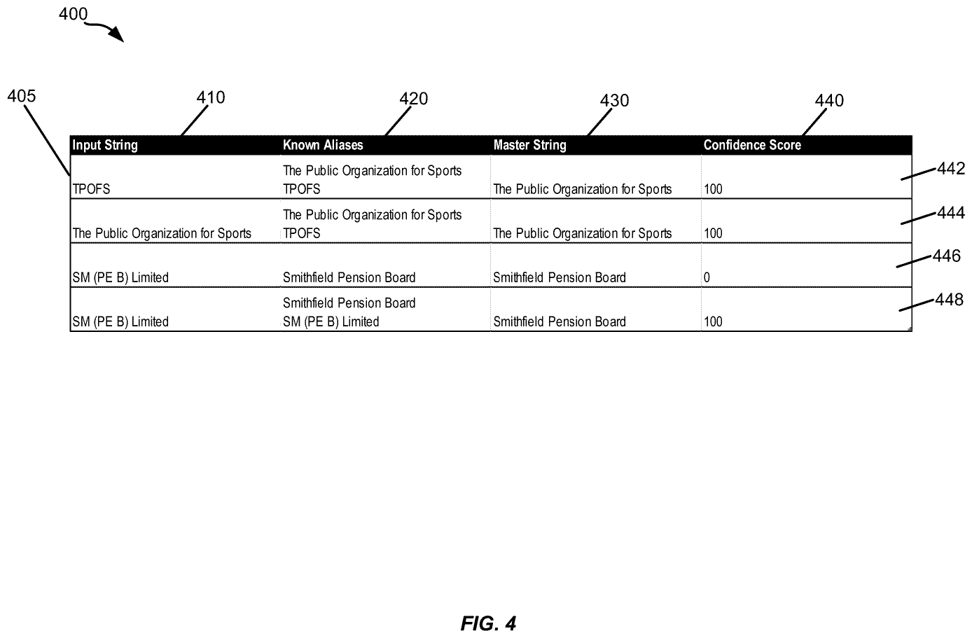

In some examples, the string matching system 100 can preprocess the input string using various preprocessing techniques prior to outputting the input string to the confidence score computation subsystems 120A..N. The preprocessing techniques can convert the input string into a format that is compatible with the respective scoring techniques. For example, preprocessing for exact match scoring may involve minimal changes such as trimming of leading or trailing whitespace. In another example, for similarity matching, the input string may be stripped of whitespace and special characters, certain common words, and then vectorized according using a vectorization process. Additional details about some example preprocessing techniques are described below in FIGS. 4-6.

At block 220, the string matching system 100 can compute one or more scores for the input string using one or more respective scoring techniques, in which each score of the one or more scores corresponds to a measure of a similarity between the input string and another string. For example, for each scoring technique of the one or more respective scoring techniques, the string matching system 100 can output the input string to a confidence score computation subsystem 120A. The confidence score computation subsystem 120A can access a matching database 130A that is populated using a number of master strings each of which can be a possible match for the input string. The matching database 130A may also be populated with additional data needed for computation of confidence scores such as known aliases or vectorized forms of the master strings. The score computer 125A of the confidence score computation subsystem 120A can generate a score using the scoring technique. The score can have an associated master string, or no string, in cases including scores below a predefined threshold, such as 1 or less.

Throughout this disclosure, examples are given in which the score is on a scale of 0 to 100, but this is merely illustrative. In various examples, the score can use any suitable scale and need not be limited to integer values. Some examples may use quantitative scores, such as letters, in lieu of numerical values. Some examples may include component for normalization of computed scores between score computers 125A..N that compute scores on differing numerical scales.

At block 230, the string matching system 100 can select a first score of the one or more scores using a predefined criteria, the first score having a corresponding first string, the first string being one of the master strings. For example, the string matching system 100 may include a score comparator 115 that receives the confidence scores, and associated master strings, computed by the various confidence score computation subsystems 120A..N and selects the maximum score. In some examples, where the confidence scores from more than one confidence score computation subsystems 120A..N have the same maximum score, the score can be chosen according to a ranked preference of the scoring techniques. Other methods can similarly be used to resolve cases involving multiple maxima, no match identified, scores that are very close (e.g., within 2 on a 100 point scale), and so on.

At block 240, string matching system 100 can output the first string, or master string. For example, the score comparator 115 can output, via the web application 110, the maximum identified score along with the corresponding master string back to the user device 102. For instance, the score and master string may be returned synchronously in response to an API request or asynchronously at a later time (e.g., several seconds or minutes later). The returned information may include additional information such as information about the scoring technique used, other lower scores and associated master strings, identified aliases, and so on.

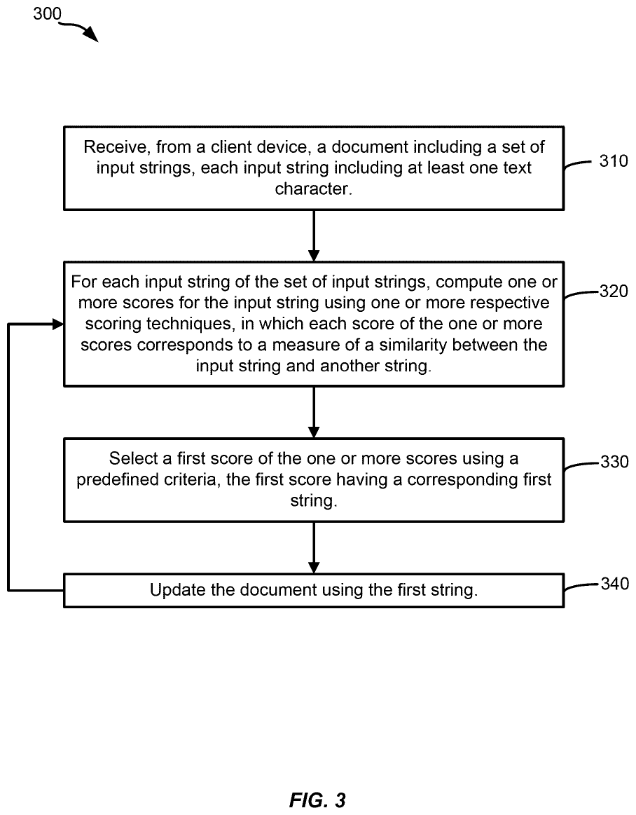

FIG. 3 depicts another flowchart of a process 300 that can be used by a system configured for data integration for strings using multiple techniques and confidence scoring, according to some examples of the present disclosure. In some examples, the string matching system 100 can implement some or all of the blocks shown in FIG. 3. The string matching system 100 can implement some or all blocks according to program code received from other components, such as components of the various confidence score computation subsystems 120A..N. Other example variations can include more blocks, fewer blocks, different blocks, or a different order of the blocks than is shown in FIG. 3. The blocks of FIG. 3 are discussed below with reference to the components discussed above in relation to FIG. 1.

At block 310, the string matching system 100 receives, from a client device, a document including a set of input strings, each input string including at least one text character. For example, the document may be a spreadsheet, text file, word-processing document, email, presentation slides, exported database table (e.g., a comma-separated values (“CSV”) file), or any other digital or digitized document that includes text strings. In an example in which the document is a spreadsheet, the spreadsheet may include a number of columns, and a particular column or columns may include the set of input strings. For instance, the spreadsheet may include data representing a number of accounts and various data such as account name, balance, interest, orders, etc. An organization may desire to standardize the account name across all data sources in use by the organization. In this case, the set of input strings corresponds to a column containing the account names. Then, each input string of the set of input strings is selected by selecting a particular row.

At block 320, the string matching system 100, for each input string of the set of input strings, computes one or more scores for the input string using one or more respective scoring techniques, in which each score of the one or more scores corresponds to a measure of a similarity between the input string and another string. Computation of the one or more scores for each input string may include scoring techniques such as a known alias search, a vector similarity search, a keyword match search, among many other possibilities. The number of scoring techniques that can be computed is not limited, although practical system design considerations, such as comprehensibility, efficiency, latency, or computational resources can limit the number of scoring techniques in use. For example, some implementations may use three scoring techniques. Some implementations may use ten or even hundreds of scoring techniques.

In some examples, for each scoring technique of the one or more respective scoring techniques, computing the confidence score may involve first accessing a matching database 130A. The matching database 130A may include a number of master strings and associated intermediate computation data (e.g., vectorized or tokenized forms of the master strings), each of which may be a possible match for the input string. The master strings and associated intermediate computation data can be retrieved from the matching database 130A and then a confidence score can be generated using the respective scoring technique. In some examples, master strings and associated data can be retrieved from the matching database 130A..N in batches. For instance, 100 scores can be computed at a time and ephemerally stored. In some examples, the score computation can be performed by the matching database itself using, for example, a stored procedure in a relational database. Other examples include using a user-defined function for other database types, an in-memory computation, a map-reduce job, using triggers, offloading computation to an external service using an event-driven framework, and so on. Likewise, score computation can proceed serially or in parallel, using a suitable parallel processing technique.

In some examples, the matching database 130A can be periodically synchronized with a master string database 135. The master string database 135 can include a set of master strings which are mirrored to each respective matching database 130A during system initialization, upon updates to the master string database 135, periodically, or in response to a manual trigger. As described above, each input string can be matched to one of the master strings along with a corresponding confidence score. In examples, in which no suitable match can be identified, according to a minimum threshold (e.g., confidence score less than 5), no master string may be determined.

At block 330, the string matching system 100, further for each input string of the set of input strings, selects a first score of the one or more scores using a predefined criteria, the first score having a corresponding first string. This block can proceed substantially as block 230 described above, for each input string. In various examples, the set of input strings can be processed individually, in subsets, all at once.

At block 340, the string matching system 100, further for each input string of the plurality of input strings, updates the document using the first string. For example, if the input document is a spreadsheet, the matched first string can be added to a second, newly created column in the spreadsheet in which each matching string is shown in the same row as the corresponding input string. Alternatively, the matched master strings can be provided as a text list, in a newly created document, as a table, or any other suitable output format. Outputting of the matching strings can proceed substantially similar to the operations described above with respect to block 240. In examples in which the input strings are processing serially or in subsets, following completion of the operations described in block 340, processing can resume with the next input string or strings among the set of input strings at block 320.

In some examples, upon outputting, to the client device, the matched first string or strings (e.g., the updated document), the string matching system 100 can receive, from the client device, an indication of an override string. For example, a user of the client device may review the updated document or list of matched strings and determine that a particular match or match is different from a desired outcome. The indication may be received by way or a suitable GUI or by another copy or updated copy of the document. The string matching system 100 can update the document using the override string and return the document to the client device.

In some examples, the override string may be an indication to update the master string associated with the first string. For example, an input string “TechCo, Inc.” in a document may be matched to the master string “Technology Company Incorporated”. The override string may be “Technology Company, Inc.” In this example, the override string can be output to the master string database 135 along with a command based on the first string configured to overwrite the first string with the override string. For example, where the master string database 135 is a relational structured query language (“SQL”)-based database, the command may be an UPDATE query to modify the table including the master strings to replace the master string “Technology Company Incorporated” with “Technology Company, Inc.” Following this update, a second command can be output to the master string database 135 to cause the master string database 135 to synchronize the newly overwritten override string with the one or more associated matching databases 130A..N.

FIG. 4 depicts an example of one scoring technique 400, according to some aspects of the present disclosure. In particular, scoring technique 400 is an example of an implementation of a scoring technique based on exact matches with known aliases. Scoring technique 400 is illustrated using the values in table 405. For clarity, scoring technique 400 is described as implemented by confidence score computation subsystem 120A.

As described in blocks 210 and 310 above, the string matching system 100 can receive one or more input strings individually or as part of a document, such as a spreadsheet. Following some preprocessing, each input string can be output to a confidence score computation subsystem 120A configured for exact string matching on known aliases. Preprocessing may be performed by the web application 110, the score computer 125A, or other dedicated preprocessing component. For instance, during preprocessing, trailing or leading whitespace may be removed or special (e.g., non-visible) characters may be removed from the input strings. Table 405 shows several example input strings 410. Various examples may use different approaches to preprocessing according to the standards used during preparing of the master strings in the master string database 135.

Scoring technique 400 will be described using an example of computing a confidence score for one input string. However, various examples may compute multiple scores simultaneously using a suitable database query or program code. Some examples may, compute confidence scores for the set of input strings or a portion thereof using parallel processing techniques.

Upon receipt of an input string by score computer 125A, the score computer 125A can access the matching database 130A. The matching database 130A may be populated with the master strings 430 copied or synchronized from the master string database 135. The matching database 130A may also be populated with a number of known aliases 420 for each of the master strings 430.

The score computer 125A can output, to the matching database 130A, a query based on the input string. The query can be configured to identify an exact match to the input string among the known aliases 420. If an exact match is identified between the input string and one string among the known aliases 420, the query can return the master string corresponding to the matching known alias. In some examples, the score computer 125A may query the matching database 130A to retrieve some or all of the known aliases 420 and perform the matching externally to the matching database 130A using suitable program code.

The score computer 125A can output to the score comparator 115 a predefined value that corresponds to an identification of an exact match. For example, a confidence score of 100 may correspond to identification of an exact match, while a confidence score of 0 may correspond to no exact match having been identified.

Table 405 shows example confidence scores 440 for the input strings 410 given an example matching database 130A populated with the master strings 430 and known aliases 420 shown in the same row. For instance, confidence score 442 is 100 based on the input string “TPOFS” being among the known aliases for “The Public Organization for Sports.” Likewise for confidence score 444. In both of these cases, the score computer 125A would return a confidence score of 100 and the master string “The Public Organization for Sports.”

In contrast, confidence score 446 is 0 because “SM (PE B) Limited” is not among the known aliases for “Smithfield Pension Board.” Confidence score 448, for the same input string, is now shown as 100 because “SM (PE B) Limited” is among the known aliases. In examples in which no exact match is identified and the confidence score is 0, no master string may be returned to the score comparator 115.

The score computer 125A can be configured to handle a variety of variations that may occur in addition to the simple examples described here. For instance, the score computer 125A may include processes for multiple matches, minor typographical errors, partial matches, variations in whitespace or special characters, variations in case, and so on. For instance, the score computer 125A may include predefined rules for selecting a master string when there are multiple matches. In some examples, the database sync service 145 may be configured to only add unique known aliases to the matching database 130A.

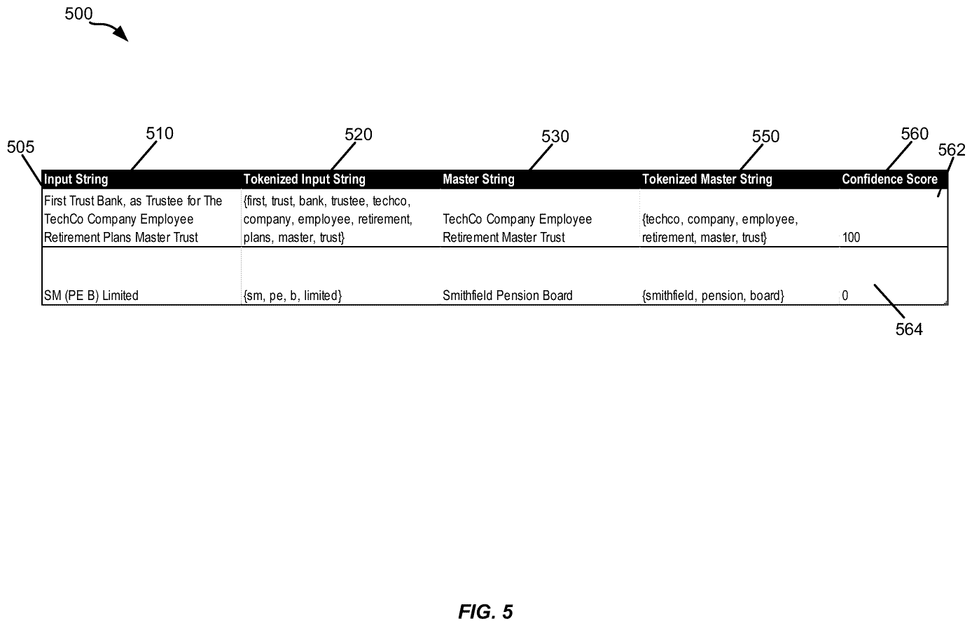

FIG. 5 depicts another example of a scoring technique 500, according to some aspects of the present disclosure. In particular, scoring technique 500 is an example of an implementation of a scoring technique based on matching keywords between the input string and the various possible master strings. Scoring technique 500 is illustrated using the values in table 505. For clarity, scoring technique 500 is described as implemented by confidence score computation subsystem 120B.

As described in blocks 210 and 310 above, the string matching system 100 can receive one or more input strings individually or as part of a document, such as a spreadsheet. Preprocessing may be performed by the web application 110, the score computer 125B, or other dedicated preprocessing component. Preprocessing for the keyword-based scoring technique can involve removing characters from the input string that are included in a predefined set of special characters. For example, the special characters may include punctuation marks, such as periods and commas; mathematical symbols, like the plus or minus signs; currency symbols, such as dollar or euro signs; control characters, like tabs or line breaks; typographical symbols, such as the ampersand or asterisk; non-printable formatting characters such as the backspace or alarm characters; and so on. These examples are given in the context of American Standard Code for Information Interchange (“ASCII”)-encoded strings, but various encoding formats may have different or additional special characters removed.

Next, during preprocessing, the input string can be “tokenized” by determining one or more input words using a predefined delimiter, such as a space or other whitespace character. For instance, the string “The Public Institution for Sports” can be tokenized into a collection of words delimited by space characters as {“The”, “Public”, “Institution”, “For”, “Sports”}. In some examples, the words may be converted to use a uniform case, such as the lower case, as {“the”, “public”, “institution”, “for”, “sports”}. Certain predefined common words can then be removed, such as articles, conjunctions, prepositions, and so on. The preprocessed collection of words may be {“public”, “institution”, “sports”}. In addition to these example preprocessing steps, other preprocessing steps may be performed such as removing leading or trailing whitespace, expanding or standardizing abbreviations, detecting and filtering out Uniform Resource Locators (“URLs”) or email addresses, spell checks, and so on.

Scoring technique 500 will be described using an example of computing a confidence score for one input string. However, various examples may compute multiple scores simultaneously using a suitable database query or program code. Some examples may, compute confidence scores for the set of input strings or a portion thereof using parallel processing techniques.

Upon receipt of an input string by score computer 125B, the score computer 125B can access the matching database 130B. The matching database 130B may be populated with the master strings 530 copied or synchronized from the master string database 135. The matching database 130B may also be populated with similarly preprocessed collections of words for each master string, as described above. These are illustrated in FIG. 5 as the tokenized master strings 550. In some examples, the keyword-matching scoring technique involves comparing the collection of words derived from each input string with the collection of words for each respective master string.

The score computer 125B can output, to the matching database 130B, a query based on the input string. The query can be configured to match the collection of words derived from each input string with the collection of words for each respective master string. In some examples, the score computer 125B may query the matching database 130B to retrieve some or all of the tokenized master strings 550 and perform the matching externally to the matching database 130B using suitable program code. In both cases, the computation can involve determining the count or fraction of each collection of words for each respective master string that are also included in the collection of words derived from the input string. For instance, if the input string's tokenized keywords are {“public”, “sports”} and, for a particular master string, the tokenized keywords are {“public”, “institution”, “sports”} , then count would be 2 and the fraction would be ⅔. The score computer 125B can then determine a confidence score for each count or fraction, where the score is a predefined value corresponding to the count or fraction. In one illustrative example, the predefined scores could be 50 if ⅓ or more of the keywords match, 90 if ⅔ or more of the keywords match, and 100 if all of the keywords match. Other fraction (and numbers of fractions) and predefined scores can likewise be used in addition to or in lieu of these examples.

Table 505 shows example confidence scores 560 for the input strings 510 given an example matching database 130B populated with the master strings 530 and tokenized master strings 550 shown in the same row. For instance, confidence score 562 of 100 based on all keywords of the tokenized input string “First Trust Bank, as Trustee for The TechCo Company Employee Retirement Plans Master Trust” being found among the keywords of the tokenized master string “TechCo Company Employee Retirement Master Trust”. The confidence score 564 of 0 is based on none of the keywords of the tokenized input string “SM (PE B) Limited” being found among the keywords of the tokenized master string “Smithfield Pension Board”.

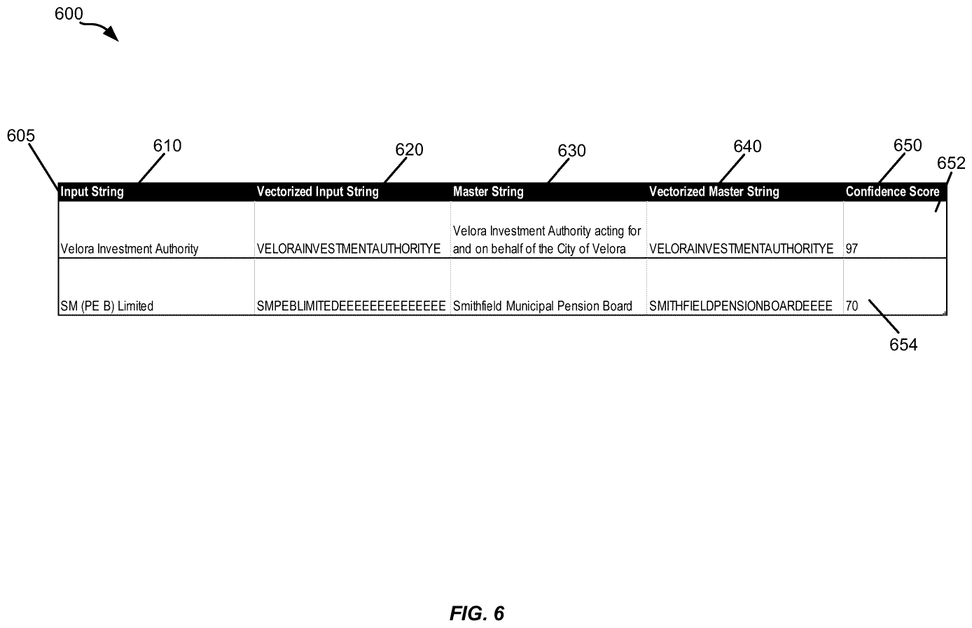

FIG. 6 depicts an example of yet another scoring technique 600, according to some aspects of the present disclosure. In particular, scoring technique 600 is an example of an implementation of a scoring technique based on matching computing a similarity score between the input string and the various possible master strings. Scoring technique 600 is illustrated using the values in table 605. For clarity, scoring technique 600 is described as implemented by confidence score computation subsystem 120C.

As described in blocks 210 and 310 above, the string matching system 100 can receive one or more input strings individually or as part of a document, such as a spreadsheet. Preprocessing may be performed by the web application 110, the score computer 125C, or other dedicated preprocessing component. Preprocessing for the similarity score scoring technique can involve removing words from the input string that are included in a predefined set of common words, similarly to the process described above with respect to FIG. 5. Preprocessing for the similarity score scoring technique can further involve removing one or more whitespace characters from the input string. For example, leading, trailing, or internal whitespace may be removed. Characters from the input string that are included in a predefined set of special characters can be removed from the input string, similarly to the process described above with respect to FIG. 5. For each lowercase character in the input string, the lowercase character can be changed to an uppercase character.

As a result of these initial preprocessing steps, an input string such as “The Public Institution for Sports” can be preprocessed to result in the string “PUBLICINSTITUTIONSPORTS”. The preprocessing component can then determine the length of the preprocessed input string. Responsive to the length being less than a predefined threshold length such as 20-30 characters, the preprocessing component can append one or more padding characters to the terminal end of the input string to increase the length of the input string to the predefined threshold length. For example, the preprocessed string “PUBLICINSTITUTIONSPORTS” includes 23 characters. For a threshold of 26 characters, the input string can be padded using a predetermined padding character such as ‘E’. The padded input string may then be “PUBLICINSTITUTIONSPORTSEEE”.

Selection of the padding character may be based on statistical properties of the alphabet in use. For example, the padding character ‘E’ may be selected since it is the most common letter in the English language and may thus have the least impact on the similarity computations described below, since ‘E’ characters are more likely to appear in potential matched strings. In another example, the character ‘M’ can be used since it is approximately in the middle of the English alphabet. Selection of ‘M’ or ‘N’ for this reason may likewise have uniform, and therefore ignorable, statistical impacts on the resultant matches. Other characters may be chosen for similar reasons. The techniques of these disclosure may be likewise applied to other alphabets or languages, which may have different considerations for selection of the padding character.

In addition to these example preprocessing steps, other preprocessing steps may be performed such as removing leading or trailing whitespace, expanding or standardizing abbreviations, detecting and filtering out URLs or email addresses, spell checks, and so on.

Scoring technique 600 will be described using an example of computing a confidence score for one input string. However, various examples may compute multiple scores simultaneously using a suitable database query or program code. Some examples may, compute confidence scores for the set of input strings or a portion thereof using parallel processing techniques.

Upon receipt of an input string by score computer 125C, the score computer 125C can access the matching database 130C. The matching database 130C may be populated with the master strings 530 copied or synchronized from the master string database 135. The matching database 130C may also be populated with similarly preprocessed collections of words for each master string, as described above. These are illustrated in FIG. 6 as the vectorized master strings 640. In some examples, the similarity score scoring technique involves comparing the vectorized form of each input string with the vectorized form for each respective master string.

Examples of similarity scoring methods that may be used for this scoring technique include computing a Euclidian distance, a Levenshtein distance, or a cosine similarity distance between the vectorized input string and the vectorized match string. The Euclidean distance can measures the straight-line distance between two points in a multi-dimensional space, such as the parameter space having the number of dimension of the length of the preprocessed, vectorized strings. The Levenshtein distance can involve calculating the minimum number of single-character edits (e.g., insertions, deletions, or substitutions) required to change one string into another. The number of such edits, character by character, can be used to compute the similarity score. Cosine similarity distance can involve computing the cosine of the angle between two non-zero vectors in a multi-dimensional space, which can provide an indication of the closeness of the direction of the respective vectors. In addition to these three examples, other similarity scoring methods can be used such as the Jaccard similarity, the Hamming distance, or the Jaro-Winkler distance, among many others.

The score computer 125C can output, to the matching database 130C, a query based on the input string. The query can be configured compute a similarity measure using at least one of the methods described above using, for example, stored procedures. In some examples, the score computer 125C may query the matching database 130C to retrieve some or all of the vectorized master strings 640 and perform the matching externally to the matching database 130C using suitable program code. In both cases, the computation can involve accessing the matching database 130C including a set of vectorized master strings based on an associated set of master strings. The query to the matching database 130C can be configured to determine a subset of the set of vectorized match strings based on the vectorized input string. For example, computing the similarity score for every possible match may be computationally inefficient. In one approach to narrowing the computational burden, only vectorized master strings beginning with the same letter as the vectorized input string may be selected. In some examples, the subset may simply be all of the vectorized master strings, in which case the computation below can be performed for all possible matches.

Then, for each vectorized match strings of the determined subset, one or more similarity scores based on the vectorized match string and the vectorized input string using at least one of the similarity score computation techniques described above can be computed. For each vectorized match string of the subset, a maximum similarity score based on similarity scores computed can be determined. For example, the input string “SM (PE B) Limited” can result in the vectorized form “SMPEBLIMITEDEEEEEEEEEEEEEE”. This may result a computed Euclidian distance from the master string “Smithfield Pension Board” having the vectorized form “SMITHFIELDPENSIONBOARDEEEE” of 50, a Levenshtein distance of 60, and a cosine similarity of 70. The maximum value for the master string “Smithfield Pension Board” can be determined to be 70. An overall maximum similarity score from the computed maximum similarity score for each of the subset of the master strings can then be determined and output, where again the output first score is the overall maximum similarity score.

Table 606 shows example confidence scores 650 for the input strings 610 given an example matching database 130C populated with the master strings 630 and vectorized master strings 640 shown in the same row. For instance, confidence score 652 of 97 based on a maximum similarity measure between the vectorized input string “VELORAINVESTMENTAUTHORITYE” and the vectorized master string “VELORAINVESTMENTAUTHORITYE”. The confidence score 654 of 70 is based on a maximum similarity measure between the vectorized input string “SMPEBLIMITEDEEEEEEEEEEEEEE” and the vectorized master string “SMITHFIELDPENSIONBOARDEEEE”. In some examples, the output confidence score may accompanied by additional information about, for example, which similarity measure was used to obtain the maximum score.

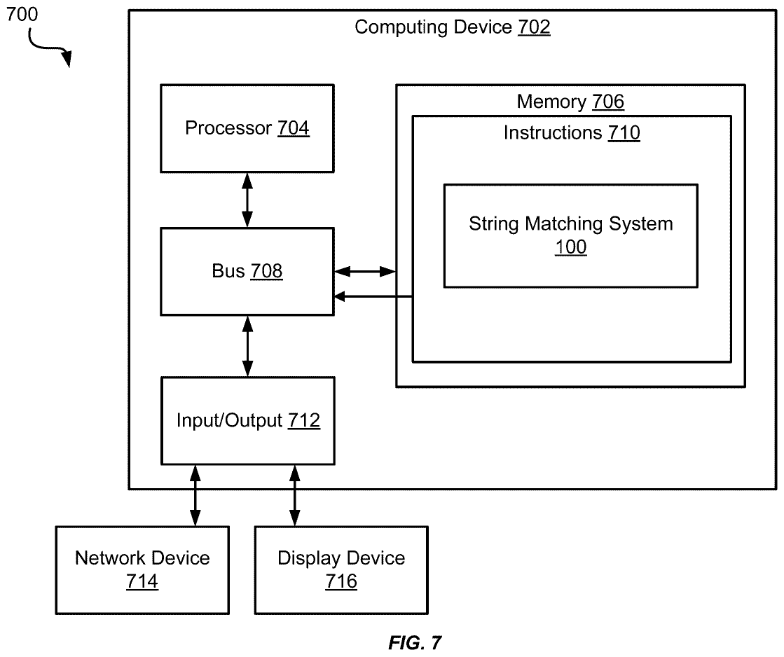

FIG. 7 is a block diagram of an example of a system 700 for data integration for strings using multiple techniques and confidence scoring, according to some aspects of the present disclosure. The system 700 may correspond to the string matching system 100 or any other component thereof. A computing device 702 can include a processing device 704, a memory 706, a bus 708, and an input/output 712. A display device 716 and network device 714 can be connected to the input/output 712. In some examples, the components shown in FIG. 7 may be integrated into a single structure. For example, the components can be within a single housing. In other examples, the components shown in FIG. 7 can be distributed (e.g., in separate housings) and in electrical communication with each other.

The processing device 704 may execute one or more operations for implementing various examples and embodiments described herein. The processing device 704 can execute instructions 710 stored in the memory 706 to perform the operations. The processing device 704 can include one processing device or multiple processing devices. Non-limiting examples of the processing device 704 include a Field-Programmable Gate Array (“FPGA”), an application-specific integrated circuit (“ASIC”), a microprocessor, etc.

The processing device 704 may be communicatively coupled to the memory 706 via the bus 708. The memory 706 may include any type of memory device that retains stored information when powered off. Non-limiting examples of the memory 706 include electrically erasable and programmable read-only memory (“EEPROM”), flash memory, or any other type of non-volatile memory. In some examples, at least some of the memory 706 may include a medium from which the processing device 704 can read instructions 710. A non-transitory computer-readable medium storing instructions may include electronic, optical, magnetic, or other storage devices capable of providing the processing device 704 with computer-readable instructions or other program code. Non-limiting examples of non-transitory computer-readable media storing instructions include (but are not limited to) magnetic disk(s), memory chip(s), ROM, random-access memory (“RAM”), an ASIC, a configured processor, optical storage, or any other medium from which a computer processor may read instructions 710. The instructions 710 may include processor-specific instructions generated by a compiler or an interpreter from code written in any suitable computer-programming language, including, for example, C, C++, C #, etc.

The input/output 712 may interface other network devices or network-capable devices to communicatively couple, for example, external user identity provider 117 to string matching system 100. Information received from the input/output may be sent to the memory 706 via the bus 708. The memory 706 can store any information received from the input/output 712.

The memory 706 may include instructions 710 for operating one or more components of the artificial account management server 107. For example, the instructions may include program code for the operation of the web application 110, score comparator, confidence score computation subsystems 120A..N, or other component (shown schematically as the string matching system 100). In some examples, the instructions may be organized into modular units or namespaces, each containing related functions and data. In some cases, program code and functionality may be consolidated into a single or small number of modules.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a system comprising: one or more processors; and one or more computer-readable storage media storing instructions which, when executed by the one or more processors, cause the one or more processors to perform operations including: receiving, from a client device, a document including a plurality of input strings, each input string including at least one text character; for each input string of the plurality of input strings: computing one or more scores for the input string using one or more respective scoring techniques, wherein each score of the one or more scores corresponds to a measure of a similarity between the input string and another string; selecting a first score of the one or more scores using a predefined criteria, the first score having a corresponding first string; and updating the document using the first string.

Example 2 is the system of example(s) 1, wherein: the document is a spreadsheet; the plurality of input strings are in a first column of the spreadsheet; each input string of the plurality of input strings is in a particular row; and updating the document using the first string comprises outputting the first string to the spreadsheet to cause the first string to appear in a second column and in the particular row associated with the corresponding input string.

Example 3 is the system of example(s) 1, wherein computing the one or more respective scoring techniques include at least one of a known alias search, a vector similarity search, and a keyword match search.

Example 4 is the system of example(s) 1, wherein computing the one or more scores for the input string using the one or more respective scoring technique comprises: for each string of at least a subset of the plurality of input strings: for each scoring technique of the one or more respective scoring techniques: accessing a database, the database including a plurality of strings, each string of the plurality of strings being a possible match for the input string; and generating a score using the scoring technique.

Example 5 is the system of example(s) 1, wherein: each scoring technique of the one or more respective scoring techniques has an associated database, wherein the associated database is periodically synchronized with a master database, the master database including a plurality of master strings, wherein the first string is selected from among the plurality of master strings.

Example 6 is the system of example(s) 5, further comprising the operations: outputting, to the client device, the first string; receiving, from the client device, an indication of an override string; and updating the document using the override string.

Example 7 is the system of example(s) 6, further comprising the operations: outputting, to the master database, a first command based on the first string, wherein the first command is configured to overwrite the first string with the override string; and outputting, to the master database, a second command to cause the master database to synchronize the override string with the one or more associated databases.

Example 8 is a computer-implemented method comprising: receiving, from a client device, a document including a plurality of input strings, each input string including at least one text character; for each input string of the plurality of input strings: computing one or more scores for the input string using one or more respective scoring techniques, wherein each score of the one or more scores corresponds to a measure of a similarity between the input string and another string; selecting a first score of the one or more scores using a predefined criteria, the first score having a corresponding first string; and updating the document using the first string.

Example 9 is the computer-implemented method of example(s) 8, wherein: the document is a spreadsheet; the plurality of input strings are in a first column of the spreadsheet; each input string of the plurality of input strings is in a particular row; and updating the document using the first string comprises outputting the first string to the spreadsheet to cause the first string to appear in a second column and in the particular row associated with the corresponding input string.

Example 10 is the computer-implemented method of example(s) 8, wherein computing the one or more respective scoring techniques include at least one of a known alias search, a vector similarity search, and a keyword match search.

Example 11 is the computer-implemented method of example(s) 8, wherein computing the one or more scores for the input string using the one or more respective scoring technique comprises: for each string of at least a subset of the plurality of input strings: for each scoring technique of the one or more respective scoring techniques: accessing a database, the database including a plurality of strings, each string of the plurality of strings being a possible match for the input string; and generating a score using the scoring technique.

Example 12 is the computer-implemented method of example(s) 8, wherein: each scoring technique of the one or more respective scoring techniques has an associated database, wherein the associated database is periodically synchronized with a master database, the master database including a plurality of master strings, wherein the first string is selected from among the plurality of master strings.

Example 13 is the computer-implemented method of example(s) 12, further comprising: outputting, to the client device, the first string; receiving, from the client device, an indication of an override string; and updating the document using the override string.

Example 14 is the computer-implemented method of example(s) 13, further comprising the operations: outputting, to the master database, a command based on the first string, wherein the command is configured to overwrite the first string with the override string; and outputting, to the master database, a command to cause the master database to synchronize the override string with the one or more associated databases.

15. A non-transitory computer-readable medium storing instructions that, when executed by one or more processors, cause the one or more processors to perform operations including: receiving, from a client device, a document including a plurality of input strings, each input string including at least one text character; for each input string of the plurality of input strings: computing one or more scores for the input string using one or more respective scoring techniques, wherein each score of the one or more scores corresponds to a measure of a similarity between the input string and another string; selecting a first score of the one or more scores using a predefined criteria, the first score having a corresponding first string; and updating the document using the first string.

Example 16 is the non-transitory computer-readable medium of example(s) 15, wherein: the document is a spreadsheet; the plurality of input strings are in a first column of the spreadsheet; each input string of the plurality of input strings is in a particular row; and updating the document using the first string comprises outputting the first string to the spreadsheet to cause the first string to appear in a second column and in the particular row associated with the corresponding input string.

Example 17 is the non-transitory computer-readable medium of example(s) 15, wherein computing the one or more respective scoring techniques include at least one of a known alias search, a vector similarity search, and a keyword match search.

Example 18 is the non-transitory computer-readable medium of example(s) 15, wherein computing the one or more scores for the input string using the one or more respective scoring technique comprises: for each string of at least a subset of the plurality of input strings: for each scoring technique of the one or more respective scoring techniques: accessing a database, the database including a plurality of strings, each string of the plurality of strings being a possible match for the input string; and generating a score using the scoring technique.

Example 19 is the non-transitory computer-readable medium of example(s) 15, wherein: each scoring technique of the one or more respective scoring techniques has an associated database, wherein the associated database is periodically synchronized with a master database, the master database including a plurality of master strings, wherein the first string is selected from among the plurality of master strings.

Example 20 is the non-transitory computer-readable medium of example(s) 15, further comprising the operations: outputting, to the client device, the first string; receiving, from the client device, an indication of an override string; and updating the document using the override string.

What is claimed is:

1. A system comprising:
one or more processors; and
one or more computer-readable storage media storing instructions which, when executed by the one or more processors, cause the one or more processors to perform operations including:
receiving, from a client device, a document including a plurality of input strings, each input string including at least one text character;
for each input string of the plurality of input strings:
computing one or more scores for the input string using one or more respective scoring techniques, wherein each score of the one or more scores corresponds to a measure of a similarity between the input string and another string;
selecting a first score of the one or more scores using a predefined criteria, the first score having a corresponding first string; and
updating the document using the first string.

2. The system of claim 1, wherein:
the document is a spreadsheet;
the plurality of input strings are in a first column of the spreadsheet;
each input string of the plurality of input strings is in a particular row; and
updating the document using the first string comprises outputting the first string to the spreadsheet to cause the first string to appear in a second column and in the particular row associated with the corresponding input string.

3. The system of claim 1, wherein computing the one or more respective scoring techniques include at least one of a known alias search, a vector similarity search, and a keyword match search.

4. The system of claim 1, wherein computing the one or more scores for the input string using the one or more respective scoring technique comprises:
for each string of at least a subset of the plurality of input strings:
for each scoring technique of the one or more respective scoring techniques:
accessing a database, the database including a plurality of strings, each string of the plurality of strings being a possible match for the input string; and
generating a score using the scoring technique.

5. The system of claim 1, wherein:
each scoring technique of the one or more respective scoring techniques has an associated database, wherein the associated database is periodically synchronized with a master database, the master database including a plurality of master strings, wherein the first string is selected from among the plurality of master strings.

6. The system of claim 5, further comprising the operations:
outputting, to the client device, the first string;
receiving, from the client device, an indication of an override string; and
updating the document using the override string.

7. The system of claim 6, further comprising the operations:
outputting, to the master database, a first command based on the first string, wherein the first command is configured to overwrite the first string with the override string; and
outputting, to the master database, a second command to cause the master database to synchronize the override string with the one or more associated databases.

8. A computer-implemented method comprising:
receiving, from a client device, a document including a plurality of input strings, each input string including at least one text character;
for each input string of the plurality of input strings:
computing one or more scores for the input string using one or more respective scoring techniques, wherein each score of the one or more scores corresponds to a measure of a similarity between the input string and another string;
selecting a first score of the one or more scores using a predefined criteria, the first score having a corresponding first string; and
updating the document using the first string.

9. The computer-implemented method of claim 8, wherein:
the document is a spreadsheet;
the plurality of input strings are in a first column of the spreadsheet;
each input string of the plurality of input strings is in a particular row; and
updating the document using the first string comprises outputting the first string to the spreadsheet to cause the first string to appear in a second column and in the particular row associated with the corresponding input string.

10. The computer-implemented method of claim 8, wherein computing the one or more respective scoring techniques include at least one of a known alias search, a vector similarity search, and a keyword match search.

11. The computer-implemented method of claim 8, wherein computing the one or more scores for the input string using the one or more respective scoring technique comprises:
for each string of at least a subset of the plurality of input strings:
for each scoring technique of the one or more respective scoring techniques:
accessing a database, the database including a plurality of strings, each string of the plurality of strings being a possible match for the input string; and
generating a score using the scoring technique.

12. The computer-implemented method of claim 8, wherein:
each scoring technique of the one or more respective scoring techniques has an associated database, wherein the associated database is periodically synchronized with a master database, the master database including a plurality of master strings, wherein the first string is selected from among the plurality of master strings.

13. The computer-implemented method of claim 12, further comprising:
outputting, to the client device, the first string;
receiving, from the client device, an indication of an override string; and
updating the document using the override string.

14. The computer-implemented method of claim 13, further comprising the operations:
outputting, to the master database, a command based on the first string, wherein the command is configured to overwrite the first string with the override string; and
outputting, to the master database, a command to cause the master database to synchronize the override string with the one or more associated databases.

15. A non-transitory computer-readable medium storing instructions that, when executed by one or more processors, cause the one or more processors to perform operations including:
receiving, from a client device, a document including a plurality of input strings, each input string including at least one text character;
for each input string of the plurality of input strings:
computing one or more scores for the input string using one or more respective scoring techniques, wherein each score of the one or more scores corresponds to a measure of a similarity between the input string and another string;
selecting a first score of the one or more scores using a predefined criteria, the first score having a corresponding first string; and
updating the document using the first string.

16. The non-transitory computer-readable medium of claim 15, wherein:
the document is a spreadsheet;
the plurality of input strings are in a first column of the spreadsheet;
each input string of the plurality of input strings is in a particular row; and
updating the document using the first string comprises outputting the first string to the spreadsheet to cause the first string to appear in a second column and in the particular row associated with the corresponding input string.

17. The non-transitory computer-readable medium of claim 15, wherein computing the one or more respective scoring techniques include at least one of a known alias search, a vector similarity search, and a keyword match search.

18. The non-transitory computer-readable medium of claim 15, wherein computing the one or more scores for the input string using the one or more respective scoring technique comprises:
for each string of at least a subset of the plurality of input strings:
for each scoring technique of the one or more respective scoring techniques:
accessing a database, the database including a plurality of strings, each string of the plurality of strings being a possible match for the input string; and
generating a score using the scoring technique.

19. The non-transitory computer-readable medium of claim 15, wherein:
each scoring technique of the one or more respective scoring techniques has an associated database, wherein the associated database is periodically synchronized with a master database, the master database including a plurality of master strings, wherein the first string is selected from among the plurality of master strings.

20. The non-transitory computer-readable medium of claim 15, further comprising the operations:
outputting, to the client device, the first string;
receiving, from the client device, an indication of an override string; and
updating the document using the override string.
